(19) United States
(12) Patent Application Publication
(10) Pub. No.: US 2008/0022216 A1
(43) Pub. Date: Jan. 24, 2008

(54) Method and system for obtaining primary search terms for use in conducting an internet search

(76) Inventor: John J. Duval, Bronxville, NY (US)

Correspondence Address: MILDE & HOFFBERG, LLP, 10 BANK STREET, SUITE 460, WHITE PLAINS, NY, 10606, US

(21) Appl. No.: 11/880,604

(22) Filed: Jul. 23, 2007

Related U.S. Application Data
(60) Provisional application No. 60/832,680, filed on Jul. 21, 2006.
(60) Provisional application No. 60/836,004, filed on Aug. 7, 2006.
(60) Provisional application No. 60/836,563, filed on Aug. 9, 2006.

(51) Int. Cl. G06F 3/00

(52) U.S. Cl. 715/762

(57) ABSTRACT

A relational database having a plurality of search terms stored in a computer memory and a graphic user interface (GUI) stored in the same or a different computer memory which can retrieve search terms from the database and is operative to form and display an XY matrix, having an X axis representing historical time and a Y axis representing a plurality of categories of subject matter. The search terms are displayed on the X axis of the matrix in accordance with their respective temporal position in history and on the Y axis of the matrix in accordance with their respective categories of subject matter. The matrix is expandable by the user in both the X axis and Y axis directions to reveal an area of the matrix together with the search terms disposed thereon.

### BACKGROUND OF THE INVENTION

The present invention relates to a method and system, including a computer database, for identifying and obtaining one or more primary search terms which may be used in conducting an Internet search for any desired subject matter.

When conducting an Internet search, using any search engine such as those accessible over the Internet at www.goggle.com; www.msn.com or www.yahoo.com, it is necessary to enter one or more “keywords”, “key terms” or “search terms”. Selecting such a keyword, key term or search term is often problematic since the search results may be too voluminous—that is, produce too many “hits”—to be of much value to the user. For example, entry of the search term “civil war” into the Google search engine will return over 50,000 results.

Often too, the results yielded by a search term may have nothing to do with the subject that the searcher is looking for. In the above example, entry of the term “civil war” in an Internet Search engine will return primarily results relating to the Civil War in the United States which took place during the years 1861 to 1865, whereas the searcher may be interested in news items relating to the possibility of a civil war in Iraq in the year 2007.

Further, the Internet searcher may have only a general idea of what is of interest to him or her and would like to explore what information is available over the Internet on one or more subjects. Such a general exploratory search is extremely difficult using keyword searches since a search engine merely provides a “look up” function, reporting results in an order specified by the search engine algorithm, without suggesting a context or environment. The searcher is thus faced with looking through volumes of information, much as one would have to do if one tried to learn about any given subject by looking through an encyclopedia. The entries in an encyclopedia, usually arranged alphabetically, may be identified and reviewed, but the encyclopedia does not make clear how the individual entries may be related to each other.

As just one example, to gain an understanding of the scientific research in physics that took place during the time frame 1890-1910, one might consider reading about the work of Albert Einstein and/or Henrich Hertz, but such an investigation of these two scientists may not lead to or identify the work of many other contributors to the physical sciences in that same time frame.

In general, the difficulties in conducting an Internet search arise through the searcher's inability to conceive, find or otherwise identify search terms which, when entered, produce a satisfactory result.

### SUMMARY OF THE INVENTION

It is a principal object of the present invention, therefore, to provide a system and method by which a user may identify and select appropriate, primary search terms, before he/she begins a search using an Internet search engine.

A further object of the present invention is to provide a system and method for displaying a static array of primary search terms, arranged by category and date, which enables a user to peruse and select appropriate search terms before launching an Internet search.

These objects, as well as further objects which will become apparent from the discussion that follows, are achieved, in accordance with the present invention, by providing a relational database stored in a computer memory as well as a graphic user interface (hereinafter “GUI”), stored in either the same or a different computer memory, that forms a display on a computer screen with a “presearch (XY) matrix” having an X axis representing historical time and a Y axis representing a plurality of categories of subject matter.

The relational database includes a large number of search terms which are accessible by the user through the GUI. When displayed, each search term is located on the X axis of the matrix in accordance with its temporal position in history and on the Y axis of the matrix in accordance with its category of subject matter.

The GUI allows the user to expand the matrix seen on the display screen in either the X axis or Y axis direction, or both, to reveal a particular area in time and subject matter, together with all the search terms that are disposed in that area. Although the matrix itself is of constant size, selected portions of the matrix can be viewed by opening one or more “windows” which contain these portions, in a manner that will be described in detail below.

The search terms are preferably words of a given language, such as English, or are graphic images, such as symbols or thumbnail images of photographs. Preferably, the search terms are brief—for example, no more than ten words in length—so that many such terms may be seen at a glance when viewing an area of the XY matrix.

The search terms may, themselves, identify historical events or they may simply be placed at the appropriate position along the X axis in accordance with the time of their appearance in history. For example, the search term “ENIAC”, acronym for “Electronic Numerical Integrator and Calculator”, which was the world's first fully electronic computer, would be located along the X axis at the year 1945, the year it was placed in operation, and along the Y axis in its category of subject matter, which, for example, might be “Inventions & Technology”.

For ease of viewing, each subject matter category (the Y or vertical axis) is preferably displayed in a different color. It has been found that 2,500 years of history may be conveniently displayed, unexpanded, on a single screen if the screen identifies historical time in 100 year increments.

An area of the XY matrix may be opened and expanded for viewing in one of three ways:
(1) A proposed search term may be entered by the user in a box on the display screen. Upon entry of such a search term, and upon pressing the “enter” key on the keyboard or clicking a “go” button on the display screen, the GUI looks for this search term within its database. If the search term is present, the GUI identifies and displays the category or categories in which the search term appears. Thereafter, the user may select a category or categories of interest and cause the GUI to display the portion or portions of the matrix which contain that search term, preferably with the search term highlighted.
(2) The user may select one of three built-in search methods: searching by terms, searching by year and searching by time period. Searching by terms has been discussed above. In searching by year or by time period, the user simply enters the year or time period in a box on the display screen and clicks the “go” button. The GUI will then select the portion of the XY matrix in that year or time period to be displayed.
(3) The user may select a period in history and a subject matter category by simply moving a cursor via a pointing device to the desired point on the matrix (or successively to a point on one axis and then to a point on the other axis) and thereafter selecting that cross point by a mouse click, keystroke or the like. Alternatively, the user may simply scroll through the matrix using “scroll bars” on the X and Y axes.

When a point on the matrix is selected and opened, all of the search terms within that area (i.e., within a particular category) are revealed and the user may review these terms in their historical context. The user may then select one or more search terms for conducting an Internet search by means of the pointing device (“point and click”). Advantageously, the user may also select a second area of the matrix so that other search terms will be displayed and may be selected as primary search terms for the Internet search. For example, the second area may include the same portion of the X axis but reveal the search terms in a different subject matter category (Y axis). In this way, the user may find not only what he/she was looking for, but may also come across some other interesting search terms to aid in finding information that he/she was not looking for originally.

According to the invention, two or more different presearch (XY) matrices may be provided to cover different categories of subject matter. For example, the subject categories of one matrix may be all sports-related, with each category devoted to a different sport (baseball, football, soccer, etc.). By limiting the categories to a specific topic, the matrix can provide finer granularity in its presentation of possible search terms.

To implement the invention, the relational database to be used by a searcher must first be created and stored in a computer memory together with a graphic user interface (GUI) for accessing desired portions of the XY matrix. In creating such a database, the first step is to select a large number of primary search terms that would be useful in conducting Internet searches. The terms can be of any nature—names of historical figures, broad terms describing concepts or classes of subject matter, narrow terms describing specific subject matter, terms of art, terminology of a given trade or practice, and the like—because such search terms, when viewed by a user, will be displayed in a context; that is, in relation to their position in historical time and their subject matter.

After initially selecting the numerous search terms, these terms are located in the XY matrix in accordance with their respective temporal positions in history (on the X axis) and their respective categories of subject matter (on the Y axis).

Finally, the search terms are stored in a relational database in association with the XY matrix so that they may be retrieved, as desired by a user, as primary search terms for conducting an Internet search.

For a full understanding of the present invention, reference should now be made to the following detailed description of the preferred embodiments of the invention as illustrated in the accompanying drawings.

### BRIEF DESCRIPTION OF THE DRAWINGS

FIG. 1 is a representational diagram of graphic user interface (GUI) on a computer display screen showing a presearch (XY) matrix having a time line on the horizontal (X) axis and various categories of subject matter on the vertical (Y) axis, all in accordance with the present invention.

FIG. 2 is a representational diagram of the GUI of FIG. 1 showing a first category of the XY matrix expanded in both the X and Y directions to reveal a number of search terms and icons.

FIG. 3 is a representational diagram of the GUI of FIG. 1 showing a second category area of the XY matrix which has been expanded to reveal additional search terms and icons.

FIG. 4 is a representational diagram of the GUI of FIG. 1, similar in presentation to FIG. 3, showing how vertical highlighting may be selected by the user.

FIG. 5 is a representational diagram of the GUI of FIG. 1, similar in presentation to FIG. 4, showing how vertical highlighting may be changed.

FIG. 6 is a representational diagram of the GUI of FIG. 1, similar in presentation to FIG. 5, showing how category areas may be aligned by means of an icon.

FIG. 7 is a representational diagram of the GUI of FIG. 1 in which a desired search term has been entered in a box by a user and the XY matrix has been modified to reveal the categories where such a search term is located.

FIG. 8 is a representational diagram of the GUI of FIG. 1 in which the portion of the XY matrix that contains the desired search term has been expanded, and the search term has been highlighted.

FIG. 9 is a representational diagram of the GUI of FIG. 1, similar in presentation to FIG. 6, showing a drop down menu for which the user may choose the mode by which the user searches the XY matrix.

FIG. 10 is a representational diagram of the GUI of FIG. 1, illustrating how an area of the XY matrix may be selected by time period.

FIG. 11 is a representational diagram of the GUI of FIG. 1 illustrating further how a specific search term may be selected and added to the “Collected Search” term box.

FIG. 12 is a representational diagram illustrating how an Internet search may be conducted following the selection of multiple search terms from the “Collected Search” term box.

FIG. 13 is a representational diagram showing how an Internet book search may be conducted using Google from a selected search term (“Trajan conquers Dacia”).

FIG. 14 is a representational diagram showing how the book search of FIG. 11 may be expanded.

FIG. 15 is a representational diagram of the GUI of FIG. 1, which enables multiple searches to be launched simultaneously, showing the results from simultaneous searches of Wikipedia, The History Channel, Reference.com and Google.

FIG. 16 is a representational diagram of the GUI of FIG. 1 displaying the specific results of a History Channel search.

FIG. 17 is a representational diagram of the GUI of FIG. 1 showing the full page view option of the results of The History Channel search shown in FIG. 14.

FIG. 18 is a flowchart showing the overall structure of the system according to the present invention, illustrating how a search by various criteria (in the top left) leads to results which can be parsed by category and time frame.

FIGS. 19A and 19B, taken together, are a flowchart showing the operation of the system according to the invention.

### DETAILED DESCRIPTION OF THE PREFERRED EMBODIMENTS

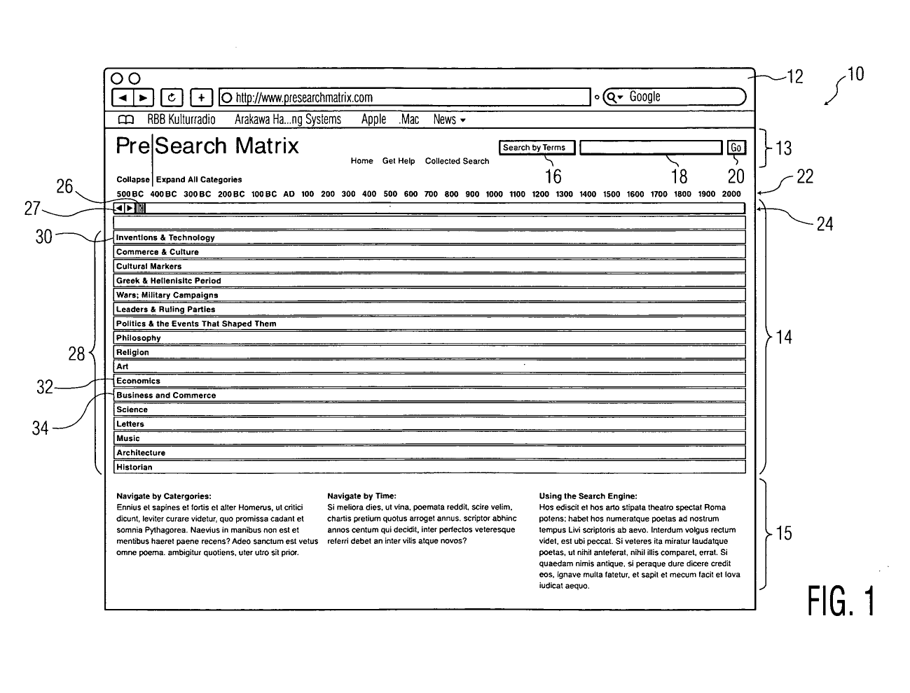

The preferred embodiments of the present invention will now be described with reference to FIGS. 1-19 of the drawings. Identical elements in the various figures are designated with the same reference numerals.

As explained above, the system according to the present invention provides a static array of Internet search terms, arranged by category and date. It is designed for Internet users to peruse before they begin a traditional keyword search using a search engine.

While search engines try to decipher true intention from natural language, the premise behind the present invention is that individuals usually have some idea of what they are looking for. If the user can take that kernel of an idea and peruse an organized index of keyword search terms related to what they already know—they will get much closer to finding what they are looking for on the Internet. This process is analogous to a person going to a library and looking up a book they have read, going to that section of the library stacks, and then perusing all the books around the one they have read in order to find similar books of interest.

The present invention thus treats its users as their own “algorithm” for finding what they are looking for. It provides them with an organized, highly efficient method of searching through a large number of related (and unrelated) items in order to discover or isolate what they want to find.

The goal of the present invention is for the user to select one, or preferably a plurality of keywords or search terms with which to launch a traditional Internet search.

Applications of the present invention are virtually limitless and can include searches for historical events, intellectual and political history, sports, news, books, music, inventions, culture, business, philosophy, religion, science, art and architecture, to name a few. While large scale XY matrices encompassing many millennia would most likely arrange events by year, other matrices could have a smaller scale. For instance, a presearch XY matrix tracking the news cycle could be scaled down to the quarter hour or even to the minute.

While different XY matrices could have different scales, preferably each matrix has a single scale that is static. Within each matrix, different time frames may be highlighted to track across categories and categories may be opened or closed as the user sees fit. However, preferably no alteration, sorting or manipulation of the data entries is permitted.

Users may collect a single search term or multiple search terms as they peruse the matrix and may launch a traditional Internet search at any time using the selected term or terms.

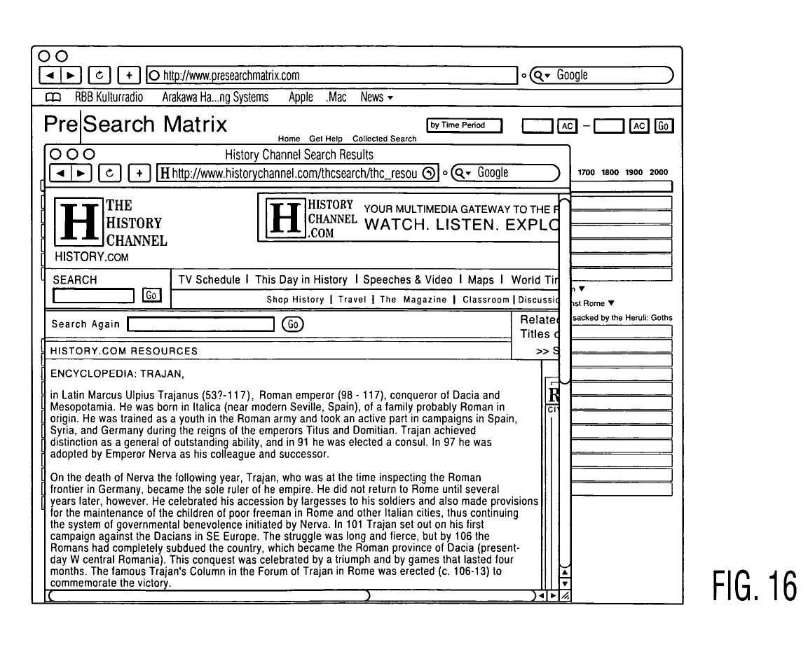

FIGS. 1-15 illustrate various computer screen displays created by the GUI in the preferred embodiment of the present invention. FIG. 16 is a flow diagram illustrating the operation of the GUI as it retrieves information from the database and displays this information in a presearch XY matrix.

FIG. 1 illustrates the “home page” 10 of the system according to the present invention, in this case in the conventional format of an Apple computer. In the embodiment shown, this home page is made available at a fictitious web site www.presearchmatrix.com. It can also be provided directly by local software running on an Apple computer, Personal computer or the like.

The tool bar 12 at the top of each web page is formed by the Internet browser or other software used by the system to display the pages and forms no part of the present invention.

The home page comprises three sections, 13, 14 and 15, which form a control area, an XY matrix area and user instruction area, respectively. The user instruction area 15 may be removed by the user, once he/she becomes familiar with the system.

The principal portions 13 and 14 of the home page 10 comprise the following elements:

### (1) A drop down menu 16 from which the user may choose the mode by which he/she searches the matrix.

### (2) A box 18 in which the user may enter one or more search terms, e.g., by typing on the computer keyboard or by pointing to such terms in the matrix, with an accompanying button 20 marked “Go” for commencing a search.

### (3) A time line 22 indicating historical time from 500 BC to 2000 AD in one hundred year increments.

### (4) A horizontal scroll bar 24 with forward and back arrows 27 and indicating, by a slide 26, a particular time period.

(5) A section 28 of categories arranged in vertical order (Y axis). This particular home page indicates seventeen different categories of subject matter. A greater or fewer number of categories may, of course, be provided.

The elements (3), (4) and (5) form the XY matrix according to the invention.

The categories shown in section 28 are exemplary only. For example, the first category 30 “Inventions & Technology” could be divided into numerous separate categories of subject matter such as Biotechnology, Computer Technology, Materials Science, Mechanical Engineering, etc.

The vertical arrangement of categories in the section 28 may also be varied, as desired. In the home page shown, the category “Economics” 32 and the category “Business and Commerce” 34 are shown adjacent to each other for convenience during use of the system. However, the categories may be arranged alphabetically, for example, or in any other manner.

The selection of subject matter of each category, and the order in which the categories are presented, is made by the designer of the XY matrix. If desired, the GUI may include a function that allows the user to reorder the vertical arrangement of the category.

Each category is shown as an individual “band” which extends horizontally from the far left to the far right of the page. Preferably, each band is represented in a different color so that a user may easily identify a category no matter where the search terms may appear along the timeline (X axis).

The user may select any desired time in history by moving the slide 26 along the scroll bar 24. This slide may be dragged by a cursor, either left or right, or moved by pressing the left and right arrow buttons 27.

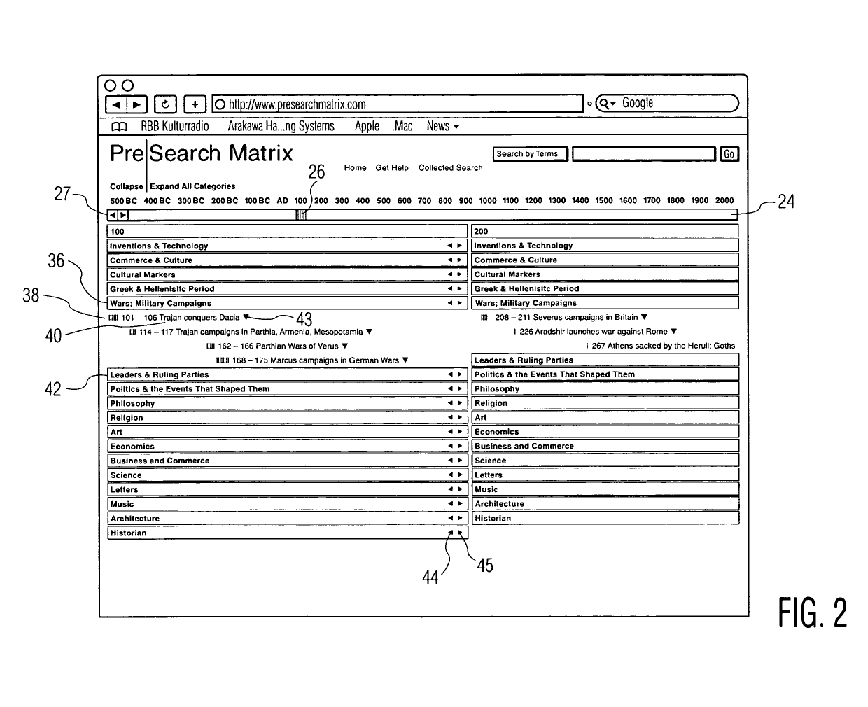

The categories on the home page are shown in “unexpanded” form. Expansion of a category will now be described with reference to FIG. 2.

In FIG. 2, the category “Wars; Military Campaigns” 36 has been selected for the time period 100-275 AD. As may be seen, two time periods (100-199 AD and 200-275 AD) are shown across the entire width of the page. If the user were to scroll to the left or right, using the scroll bar arrows 27 or the slide 26, they could retrieve and see all the “Wars; Military Campaigns” information for the time horizon for the matrix, as displayed on the screen and, by scrolling forward or backward in time, for the entire timeline.

FIG. 2 thus illustrates how the XY matrix of FIG. 1 may be used to reveal entries that may be used as search terms. For example, during the time period 101-106 AD, illustrated by the time bar 38 in FIG. 2, the matrix reveals the entry 40 “Trajan conquers Dacia”. As explained above, all of the potential search term entries in the matrix (hereinafter simply called “search terms”) are assigned to a historical time period (X axis) and a category (Y axis) of the XY matrix formed by the GUI.

To the right of each search term is a triangular icon 43. This icon allows the user to select the entry for use as a search term in launching a search by pointing and clicking on this user interactive spot.

Left and right arrows 44 and 45 are shown at the right hand end of the 100 year period for each category. Pointing and clicking on the right arrow aligns the category with the same category in the next century. Pointing and clicking on the left arrow aligns this category with the same category in the previous century.

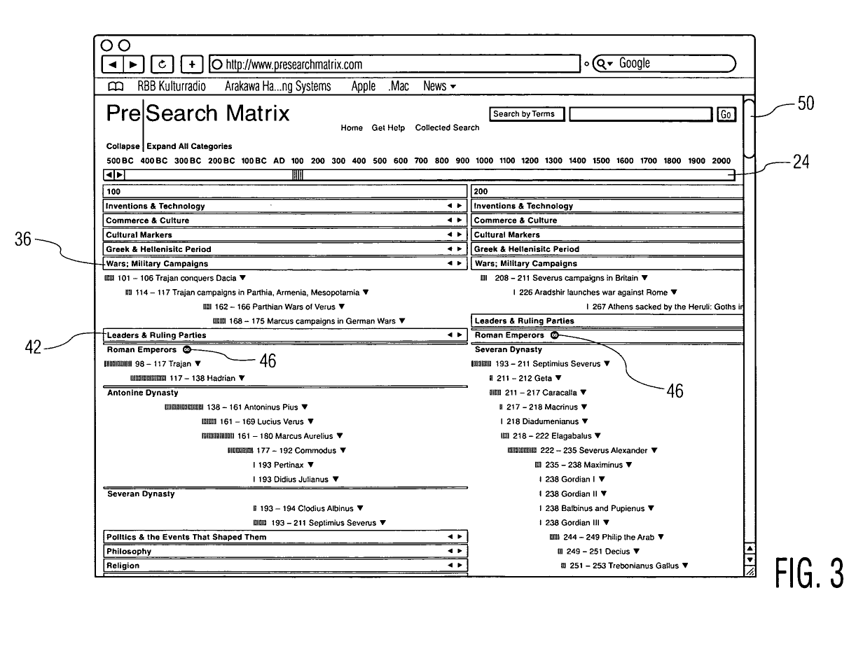

The usefulness of arranging the search terms in an XY matrix is illustrated in FIGS. 2 and 3. In FIG. 3, the category “Leaders & Ruling Parties” 42 has been opened in addition to the category “Wars; Military Campaigns” 36 for the same time period as shown in FIG. 2. This arrangement enables a user to compare and contextualize leaders and wars during the period shown; namely, from 100 to 275 AD. Viewing category 42 in the far left of the diagram, it may be seen that Trajan was the Roman Emperor during the period from 98 to 117 AD. With the two categories 36 and 42 juxtaposed, the military campaigns of Trajan may be seen at a glance.

A special icon 46 is provided to the right of each major heading—e.g., “Roman Emperors”—in each subject category. This icon permits the user to link directly to another XY matrix that is dedicated to the subject matter of this heading—“Roman Emperors”.

Since the category “Leaders & Ruling Parties” for the period 200-275 extends downward below the bottom of the screen when expanded as shown, the display screen is provided with a slide 50 to allow the user to scroll down and view the additional entries not visible on the initial screen.

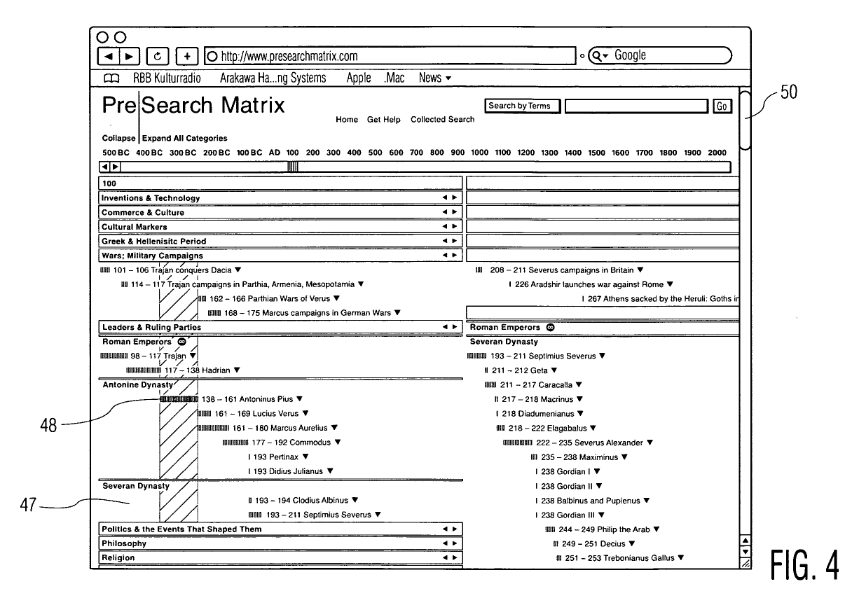

FIG. 4 illustrates how the user may cause a time period to be highlighted in the vertical direction so that entries in various categories during this time period can be compared. By pointing and clicking on a time bar—in this case time bar 48 indicating the period 138-161 for the Emperor Antonious Pius—the time bar becomes darker and a vertical region 47 the width of this time bar is highlighted.

As noted above in connection with FIG. 3, expansion of the subcategory “Roman Emperors” is continued on the right side of the display through the year 275 AD, illustrating the reigns of Roman Emperors up to this date. Since the XY matrix, so expanded, extends downward too far for viewing on a single page, the user must scroll down using the slide 50 at the right side of the screen.

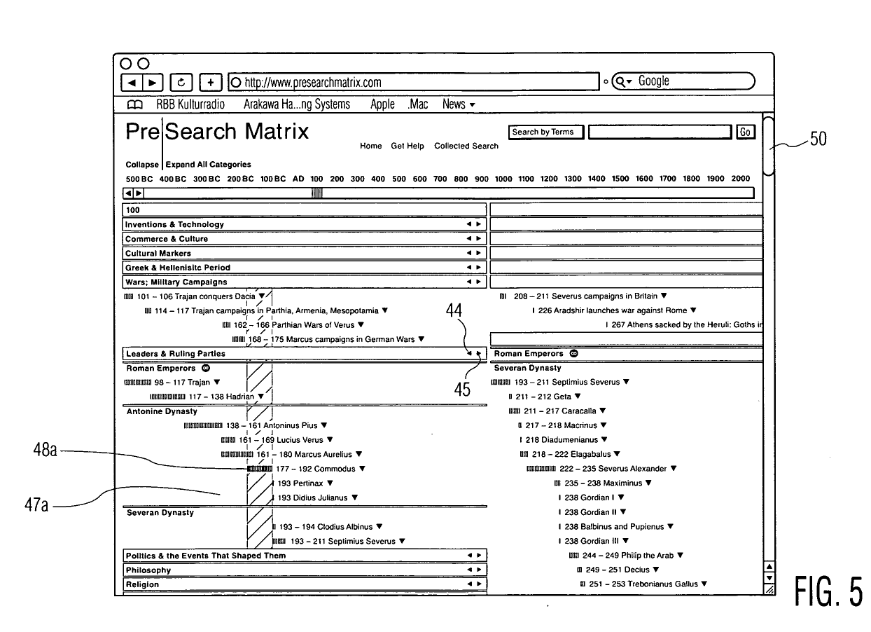

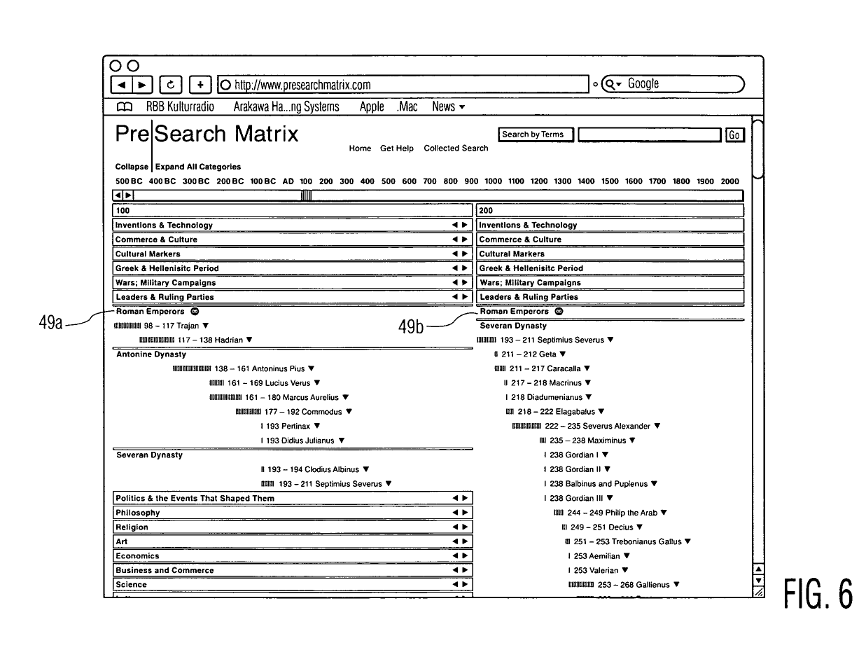

FIGS. 5 and 6 illustrate the function of the right and left arrows 44 and 45. In this case, a user has pointed and clicked on the right arrow 45 (FIG. 5) to align the categories “Leaders & Ruling Parties” (FIG. 6). Similarly, if the left arrow 44 were visible on the right side of the screen, the user could align the expanded categories by pointing and clicking on this arrow.

FIG. 6 shows the categories “Leaders & Ruling Parties” after they have been aligned.

In FIG. 5, a different time period 48a has been highlighted to provide an associated vertical time bar 47a.

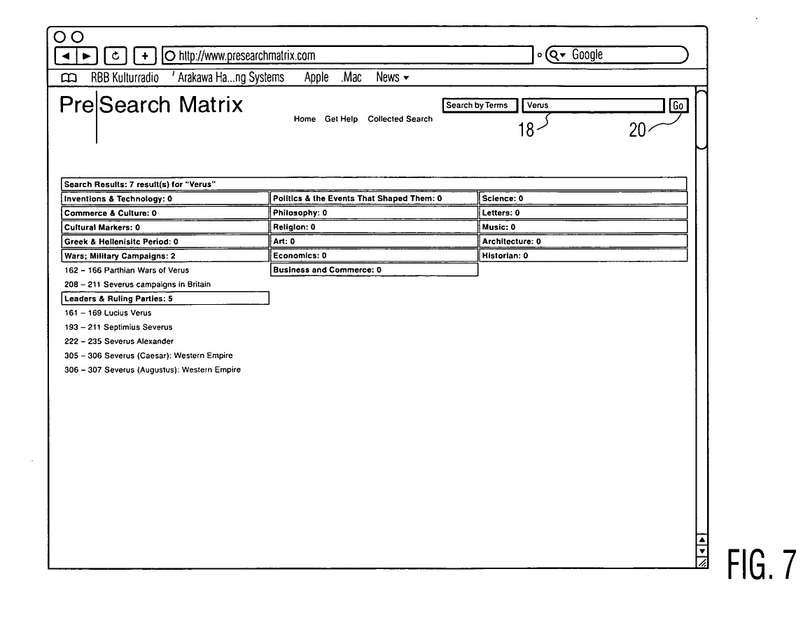

FIG. 7 illustrates how search terms may be identified and located in the XY matrix. The user, in this case, has entered the word “Verus” in the search bar 18 and pressed the button “Go” using the pointing device (e.g., mouse) of the computer. The GUI shows the results on a separate screen which lists all the categories of the XY matrix. As indicated in FIG. 7, there were seven hits from the search, two under the category “War; Military Campaigns” and five under the category “Leaders & Ruling Parties”. A “0” is indicated in each of the remaining categories.

It should be noted that some of the search results for the term “Verus” were for the name “Severus”, which incorporate the term “Verus”. Only two of the results: “Parthian Wars of Verus” under “Wars; Military Campaigns” and “Lucius Verus” under “Leaders & Ruling Parties” were for Verus alone.

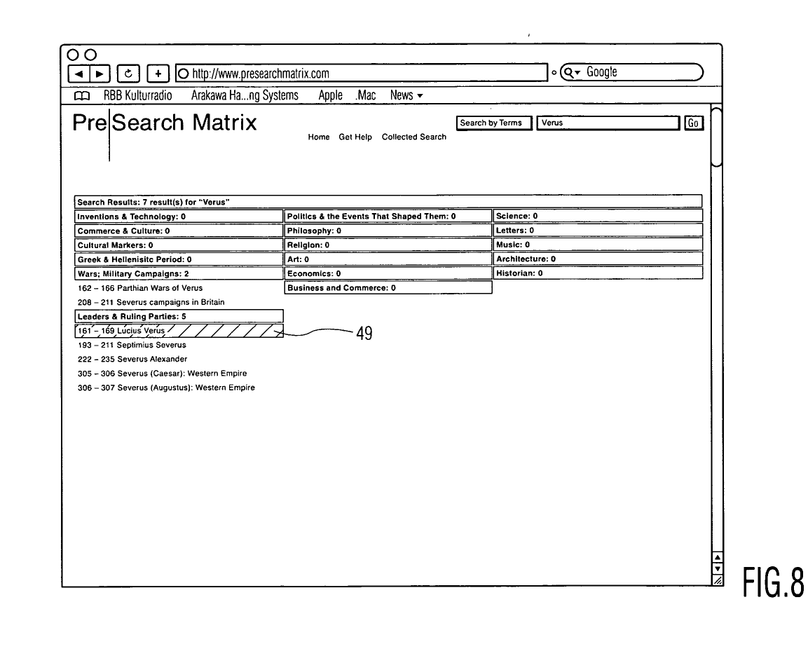

Referring to FIG. 8, if the user selects “Lucius Verus” from the search results in FIG. 7, the GUI displays the “Leaders & Ruling Parties” category expanded with the Lucius Verus entry 49 highlighted. This Roman Emperor is shown as being co-ruler with Marcus Aurelius during the period 161-169 under the subheading “Roman Emperors”.

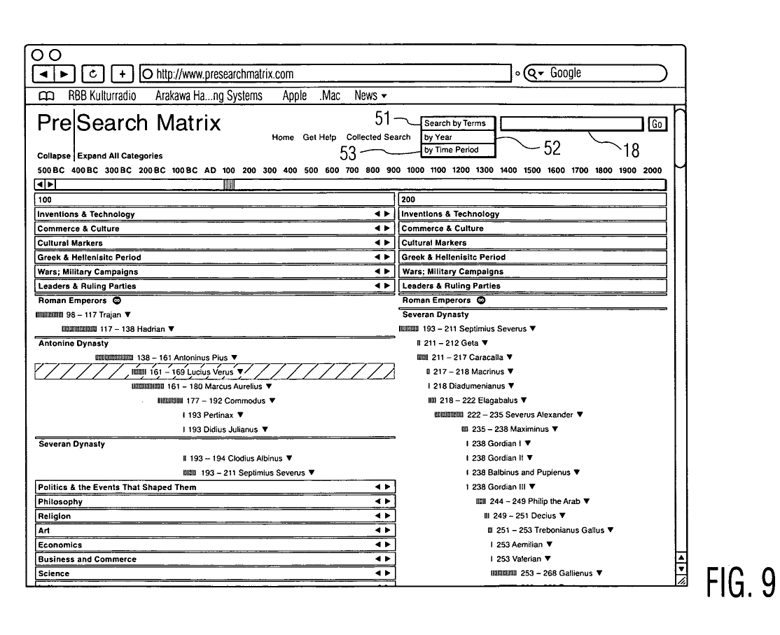

FIG. 9 is substantially identical to FIG. 6 except that the user has opened the drop down menu 16 to allow the searcher to select one of three search modes:

(1) Mode “By Word” 51 allows the searcher to select a search term by typing it into the box 18 or by using the pointing device of the computer. The user may expand any category during any time period and select a search term by pointing and clicking on that term.

### (2) Mode “By Year” 52 allows the user to select a particular year, and then open a category, or multiple categories, to reveal the search terms for that year.

### (3) Mode “By Time Period” 53 allows the user to select all entries within a prescribed time period.

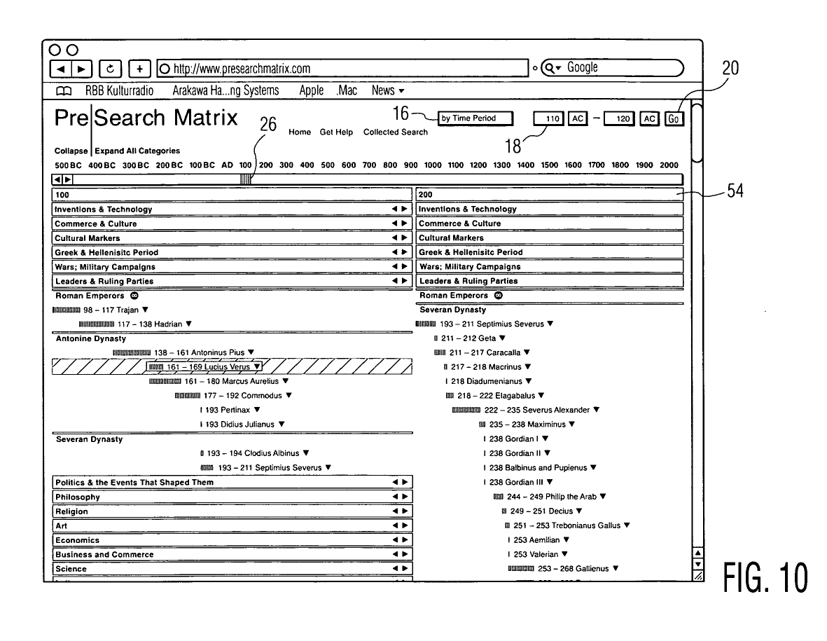

For example, in FIG. 10 the user has selected the mode “By Time Period” in box 16 and the ten year period from 110 AD to 120 AD in box 18. Upon pressing the “Go” button 20, the GUI displays the results in the manner shown. In this case, all information that appears under each category, or a selected category, is displayed. Furthermore, the time period may be highlighted in a vertical column or columns that is/are the same width as the time period. The user could then expand other categories and the same time period would highlighted across all categories, allowing for easy contextualization and examination of the information during and around the selected years.

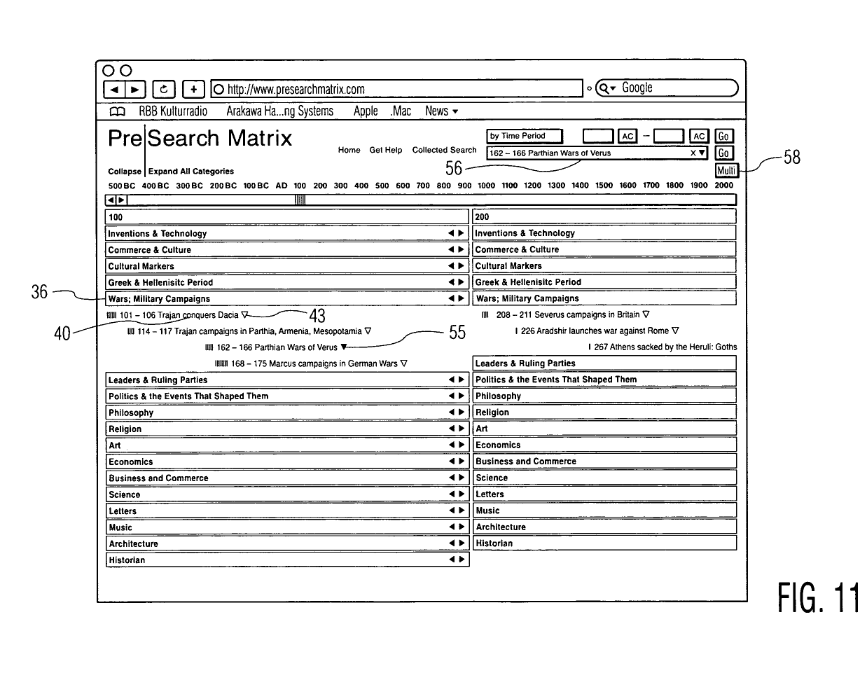

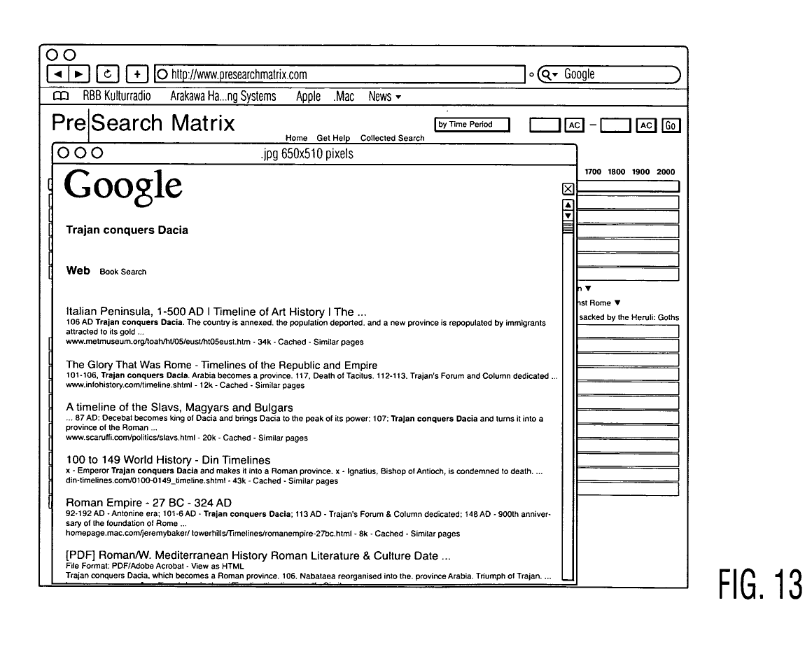

FIGS. 11-17 illustrate how a user may select a search term and proceed with a traditional Internet search using the GUI according to the invention. If the user starts with the expanded matrix shown in FIG. 11, which is identical to that of FIG. 2, he/she may click the icon 43 on the first entry under the category “Wars; Military Campaigns” 36—namely, the search term 40 “Trajan conquers Dacia”—and launch a Google web search from the “Collected Search” term box 56 to obtain detailed information about this topic. The results of the search are displayed in a front window as shown in FIG. 13. Clicking on any of the web sites listed in the search results brings the user to that selected site.

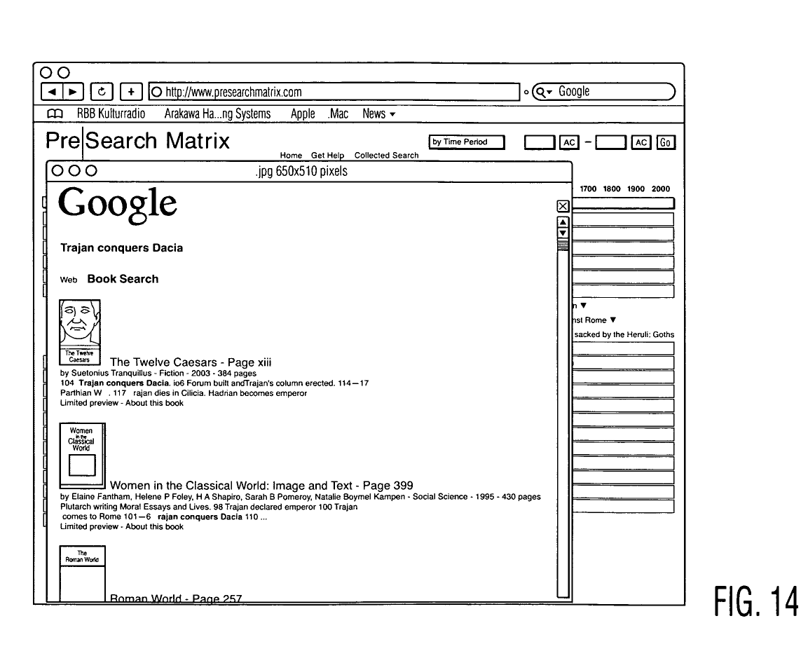

Alternatively, or in addition, the user can launch a book search through Google by clicking on the words “Book Search” which appear on the third line of the window in FIG. 13. These search results will then be listed in a new front window as shown in FIG. 14.

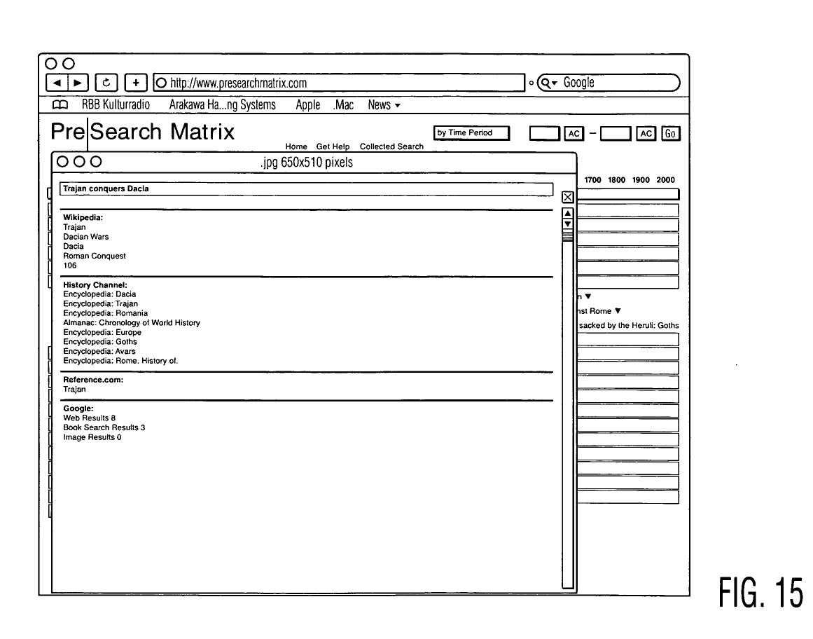

Multiple searches may be launched as well by clicking on the “multi” button in FIG. 11. The results of searches of Wikipedia, The History Channel, Reference.com and Google are displayed (and could include other search engines) in the front window as shown in FIG. 15. From this window, the user can select one of the search result entries by pointing and clicking. For example, if the user selected “Encyclopedia: Trajan”, this item from The History Channel would be displayed in the manner shown in FIG. 16.

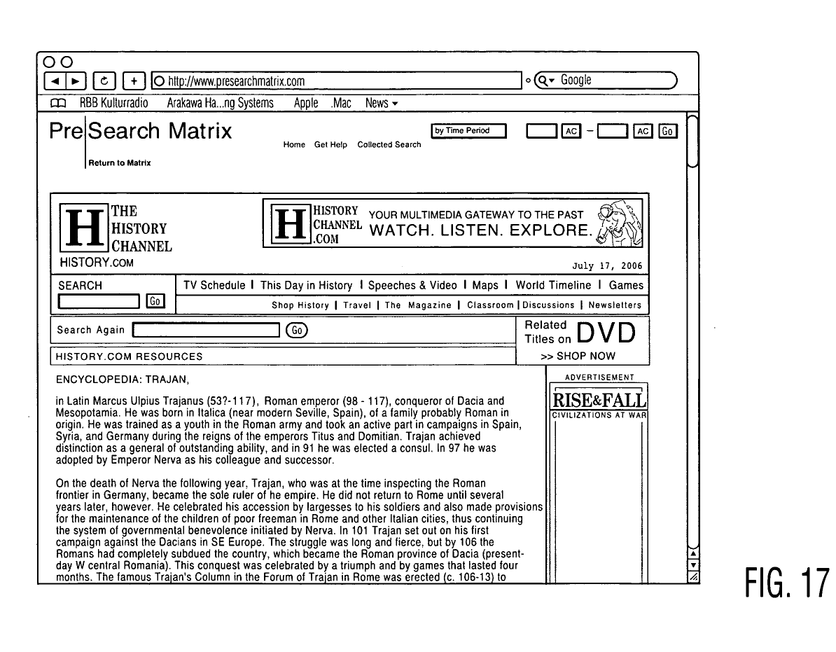

FIG. 17 demonstrates the full page view option of the detailed information on The History Channel. From this page, the user may explore further options and obtain information on any other desired topic.

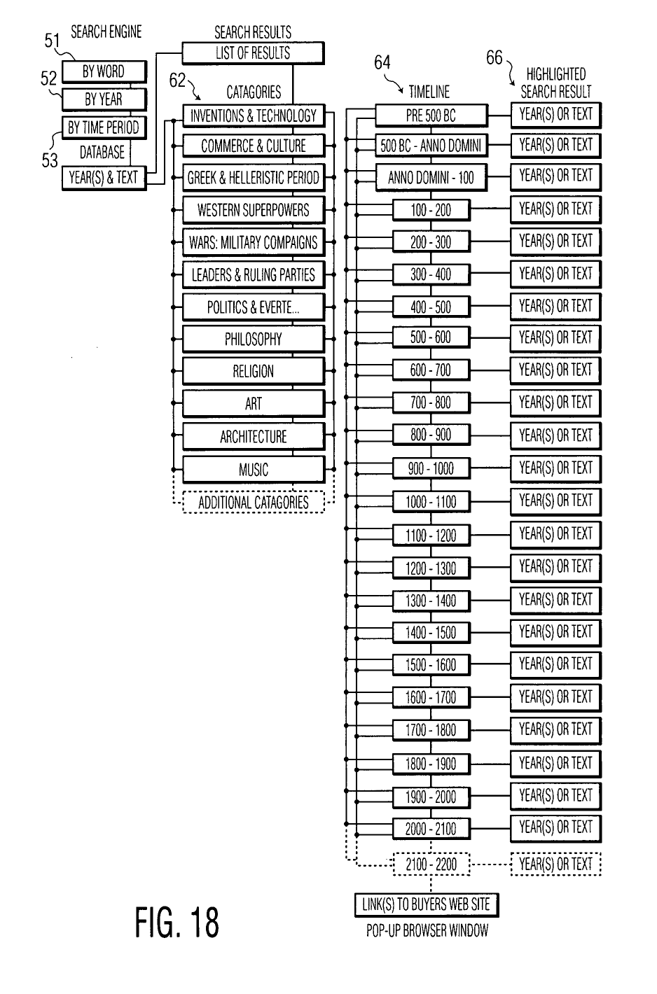

The structure the graphic user interface (GUI) according to the invention is illustrated in FIG. 18. This figure is a flowchart showing how a search for primary search terms may be conducted using the XY matrix in accordance with the various criteria or “modes” (in the top left); namely, “By Word” 51, “By Year” 52 and “By Time Period” 53. A search by one or more of these criteria leads to results which can be parsed by subject matter, category and time frame to the user's specifications. Thereafter, more detailed information can be searched and accessed through the user's own computer or via outside sources on the Internet.

According to the invention, the user commences selection of primary search terms by choosing one of the three modes 51, 52 and 53 and then accessing the database through the GUI and the XY matrix. The search terms in the relational database are then displayed by the GUI in the manner described above. The database itself is organized by category as indicated in the column 62 and by timeline as indicated in the column 64. The highlighted search terms, which are obtained at the cross points of the XY matrix, shown in the column 66, are highlighted on the display screen.

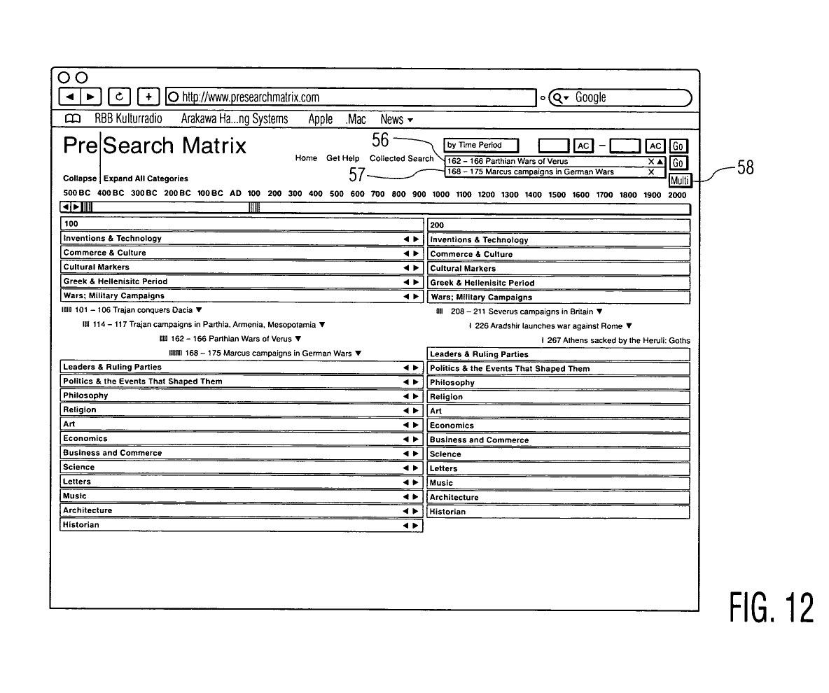

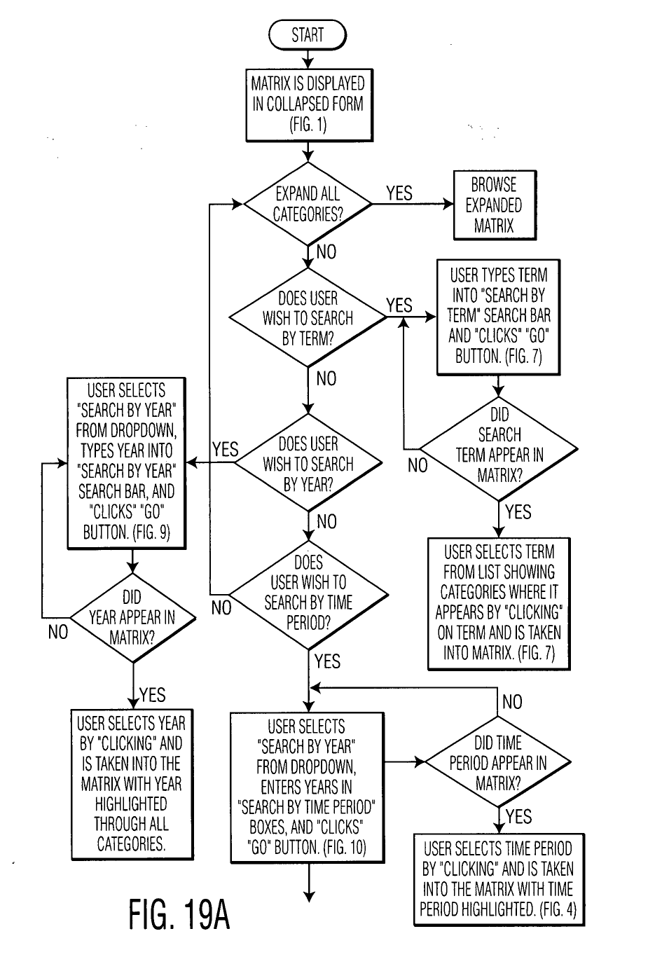

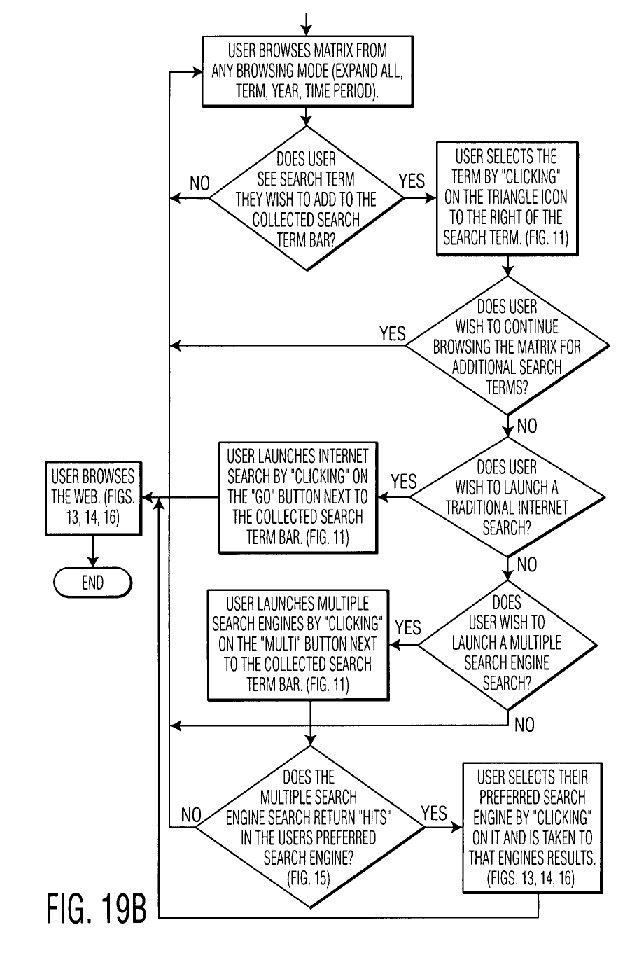

FIGS. 19A and 19B are a flowchart detailing the various possible steps and choices involved in the operation of the system. The matrix is initially displayed in collapsed form. Thereafter, the matrix can be expanded, browsed and searched to find search terms, and an Internet search is launched based on these search terms. By clicking on a button 58 in the upper right corner of the matrix marked “Multi” (FIGS. 11 and 12) the user can launch multiple search engines simultaneously.

There has thus been shown and described a novel method and system for obtaining primary search terms for use in conducting an Internet search which fulfills all the objects and advantages sought therefor. Many changes, modifications, variations and other uses and applications of the subject invention will, however, become apparent to those skilled in the art after considering this specification and the accompanying drawings which disclose the preferred embodiments thereof. All such changes, modifications, variations and other uses and applications which do not depart from the spirit and scope of the invention are deemed to be covered by the invention, which is to be limited only by the claims which follow.

What is claimed is:

1. A relational database having a plurality of search terms stored in a computer memory and a graphic user interface (GUI) stored in a computer memory which can retrieve search terms from the database and is operative to form and display an XY matrix having an X axis representing historical time and a Y axis representing a plurality of categories of subject matter, said matrix being expandable by the GUI at the option of the user in at least one of the X axis and Y axis directions to reveal an area of the matrix together with search terms disposed thereon, wherein each search term stored in the database is associated with, and located by the GUI on, the X axis of the matrix in accordance with its temporal position in history and on the Y axis of the matrix in accordance with its category of subject matter.

2. The database and GUI defined in claim 1, wherein the search terms are words of a given language.

3. The database and GUI defined in claim 2, wherein the search terms are no more than ten words in length.

4. The database and GUI defined in claim 1, wherein the search terms are graphic images.

5. The database and GUI defined in claim 1, wherein at least some of the search terms identify historical events.

6. The database and GUI defined in claim 1, wherein each category of subject matter is displayed in a different color.

7. The database and GUI defined in claim 1, wherein the time associated with the X axis is initially displayed in 100 year increments.

8. The database and GUI defined in claim 1, wherein the time associated with the X axis, when the X axis is expanded, is displayed in one year increments.

9. The database and GUI defined in claim 1, wherein the GUI includes a box for the user to enter at least one search term, wherein said GUI is responsive to a search category in which the search term appears, and wherein said GUI is responsive to a selection by the user to display one of the categories that were identified.

10. The database and GUI defined in claim 1, wherein the GUI includes a box for the user to enter at least one search term and wherein the user may select a category of interest and cause the GUI to display an area of the matrix containing the selected category together with all the search terms that are disposed therein, including the search term entered in the box.

11. The database and GUI defined in claim 10, wherein the search term entered in the box is highlighted on the matrix.

12. The database and GUI defined in claim 1, wherein the GUI is responsive to a pointing device to select at least one of a plurality of search terms by pointing to it on the matrix and thereafter to conduct an Internet search using said selected search terms.

13. A method of obtaining primary search terms for use in conducting an Internet search for any desired subject matter, said method using a relational database having a plurality of search terms stored in a computer memory and a graphic user interface (GUI) stored in a computer memory which can retrieve search terms from the database and is operative to form and display an XY matrix on which said search terms are disposed, the matrix having an X axis representing historical time and a Y axis representing a plurality of categories of subject matter, wherein each search term is located on the X axis of the matrix in accordance with its temporal position in history and on the Y axis of the matrix in accordance with its category of subject matter; said method comprising the steps of:
(a) selecting a desired area of the matrix that has desired portions of its X and Y axes;
(b) displaying the selected area of the matrix to show the search terms that are located in that area; and
(c) selecting one or more of the search terms displayed in the selected area for use as primary search terms in conducting an Internet search.

14. The method defined in claim 13, further comprising the step of selecting a second area of the matrix with other portions of at least one of the X and Y axes of the matrix so that other search terms will be displayed and may be selected as additional primary search terms for the Internet search.

15. The method defined in claim 14, wherein the second area of the matrix is adjacent to the first desired area that was selected.

16. The method defined in claim 13, wherein, in step (a), the area is selected by selecting a desired category and a desired point in time.

17. The method defined in claim 16, wherein the area is selected by sequentially selecting a point on one of said X and Y axes and thereafter selecting a point on the other one of said axes.

18. The method defined in claim 13, wherein, in step (a), the area is selected by selecting a search term that is located in that area.

19. The method defined in claim 13, further comprising the step of highlighting a portion of the selected area in response to a selection by a user.

20. The method defined in claim 13, further comprising the steps of:
(d) displaying a second area of the matrix to show additional search terms that are located in the second area on at least one of the X and Y axes; and
(e) selecting one or more of the search terms displayed in the second area for use as primary search terms in conducting the Internet search.

21. The method defined in claim 13, wherein the GUI is responsive to a pointing device to conduct an Internet search based on at least one of a plurality of search terms when a user selects one of said search terms by pointing and clicking thereto on the matrix.

22. The method defined in claim 21, wherein the GUI is responsive to the selection of multiple search terms by a user to launch an Internet search based on said multiple search terms.

23. The method defined in claim 21, wherein a time period selected by the user may be highlighted by the GUI across categories by pointing the clicking.

24. The method defined in claim 21, wherein the GUI includes a device, responsive to a user entry, for selecting an Internet search engine for conducting the Internet search.

25. A method of obtaining primary search terms for use in conducting an Internet search for any desired subject matter, said method using a relational database having a plurality of search terms stored in a computer memory and a graphic user interface (GUI) stored in a computer memory which can retrieve search terms from the database and is operative to form and display an XY matrix on which said search terms are disposed, the matrix having an X axis representing historical time and a Y axis representing a plurality of categories of subject matter, wherein each search term is located on the X axis of the matrix in accordance with its temporal position in history and on the Y axis of the matrix in accordance with its category of subject matter; said method comprising the steps of:
(a) selecting an initial search term;
(b) conducting a preliminary search of the matrix to determine if the initial search term appears therein;
(c) if the initial search term is found in the matrix, displaying a list of all categories of the matrix which contain that search term;
(d) selecting the search term that is located in the matrix in the relevant category and time frame; and
(e) selecting one or more of the search terms displayed in the selected area for use as primary search terms in conducting an Internet search.

26. The method defined in claim 25, further comprising the step of selecting a particular occurrence of the initial search term in the matrix, when this search term appears more than once in the matrix, prior to conducting step (c).

27. The method defined in claim 25, wherein the matrix is displayed in a graphic user interface (GUI), wherein the GUI includes a box for the user to enter a search term, and wherein said GUI is responsive to a search term entered in the box to display the list of the categories of the matrix which contain that search term.

28. The method defined in claim 25, wherein the search term entered in the box is highlighted on the matrix when the area is displayed.

29. The method defined in claim 25, wherein the GUI is responsive to a pointing device to conduct an Internet search of a search term when a user selects this search term by pointing to an adjacent icon on the matrix and clicking.

30. The method defined in claim 29, wherein the icon selected by the user is highlighted by the GUI.

31. The method defined in claim 29, wherein the GUI includes a device, responsive to a user entry, for selecting an Internet search engine for conducting the Internet search.

32. The method defined in claim 25, further comprising the step of selecting a second area of the matrix with other portions of at least one of the X and Y axes of the matrix so that other search terms will be displayed and may be selected as primary search terms for the Internet search.

33. The method defined in claim 32, wherein the second area of the matrix is adjacent to the first desired area that was selected.

34. The method defined in claim 25, further comprising the steps of:
(e) displaying a second area of the matrix to show additional search terms that are located in the second area on at least one of the X and Y axes; and
(f) selecting one or more of the search terms displayed in the second area for use as primary search terms in conducting the Internet search.

35. A method for assisting a person in conducting an Internet search for any desired subject matter, said method comprising the steps of:
(a) selecting a plurality of primary search terms;
(b) locating the search terms in an XY matrix having an X axis representing historical time and a Y axis representing a plurality of categories of subject matter, said search terms being arranged in accordance with their respective temporal positions in history (on the X axis) and their respective categories of subject matter (on the Y axis);
(c) storing the XY matrix with the search terms in a computer memory as a relational database, with each term associated with at least one point in time and at least one category of subject matter.

36. The method defined in claim 35, wherein, in step (a), the primary search terms are words of a given language.

37. The method defined in claim 36, wherein, step (a), the primary search terms are no more than ten words in length.

38. The method defined in claim 35, wherein, in step (a), the primary search terms are graphic images.

39. The method defined in claim 35, wherein, in step (a), at least some of the primary search terms identify historical events.
